(19) United States
(12) Patent Application Publication
(10) Pub. No.: US 2022/0081815 A1
(43) Pub. Date: Mar. 17, 2022

(54) A FABRIC IMPREGNATED WITH ORGANOSILANE FOR PURIFICATION OF LIQUIDS

(71) Applicant: Conopco, Inc., d/b/a UNILEVER, Englewood Cliffs, NJ (US)

(72) Inventors: Udayan MAJUMDAR, Bangalore (IN); Venkataraghavan RAJANARAYANA, Bangalore (IN); Priyanka SARKAR, Kolkata (IN)

(73) Assignee: Conopco, Inc., d/b/a UNILEVER, Englewood Cliffs, NJ (US)

(21) Appl. No.: 17/612,680

(22) PCT Filed: May 14, 2020
(86) PCT No.: PCT/EP2020/063504

§ 371 Date: Nov. 19, 2021

(30) Foreign Application Priority Data
May 27, 2019 (EP) 19176657.5

(51) Int. Cl. D04H 3/009; C02F 1/00; A01N 55/00

(52) U.S. Cl. CPC D04H 3/009; C02F 1/001; D10B 2331/30; D10B 2505/04; A01N 55/00

(57) ABSTRACT

The present invention relates to a fabric for purification of water. An object of the present invention is to provide a fabric for purification of liquids which achieves at least 2 log reductions of bacteria, and viruses. It is a further object of the present invention to provide a fabric for purification of liquids which provides high flow rates in gravity fed water purification systems. The present inventors have surprisingly found that a fabric having a matrix of polymer impregnated with organosilane superimposed on a surface of the fibre of a fibrous support not only provides reduction of viruses from a liquid to be purified at low pressure drops but also removes bacteria without using a separate microfiltration membrane and also retains high flow rates.

### FIELD OF THE INVENTION

The present invention relates to a fabric for purification of liquids. More particularly the invention relates to an organosilane impregnated fabric capable of providing protection against bacteria and viruses. The invention more particularly relates to a flat sheet fabric impregnated with organosilane.

### BACKGROUND OF THE INVENTION

Water usually contains three types of impurities. The first is suspended or particulate matter; dissolved chemicals come next, followed by microorganisms. Bacteria, viruses and cysts are the most common microbial contamination in water and are responsible for millions of deaths each year. Water purification processes that successfully eliminate bacteria, viruses and cysts from water sources can be expensive. The purification methods include use of chemicals and radiation. It is desired to find effective, low cost technologies to eliminate this type of contamination.

Microfiltration is a known technology utilized for water purification. Microfiltration membrane separates particles on the basis of size, by passing a solution or suspension through a fine pore-sized filter. Microfiltration membrane is generally a tough, thin, selectively permeable membrane that retains most macromolecules and or particles above a certain size, including most bacteria. Microfiltration membranes, however, cannot be used to exclude particles or organisms smaller than the filter pore size, like viruses. Viruses can however be removed from feed solutions by ultrafiltration, nanofiltration or reverse osmosis. These types of membrane filtration techniques require costly materials and high pressure operations.

Improvements in filters that can effectively remove viruses and can retain the benefits of low pressure operation, remain desirable.

European Patent Application No. EP15155569.5 (Unilever) discloses a filter for purification of liquids having a fibrous support composed of fibres and a matrix of polymer with copper impregnated therein characterised in that the matrix of polymer is superimposed on the surface of the fibres. However the functional fibre cannot remove >2 log bacteria without a separate microfiltration membrane. Copper is known for better virucide and bacteriocide. So, there was a need for another technology to remove both virus and bacteria without a separate MF unit at high flowrate.

A challenge faced by the present inventors is to provide safe water which is free from viruses and bacteria while providing high flow rates.

An object of the present invention is to provide a fabric for purification of liquids which achieves at least 2 log reduction of viruses, and bacteria preferably at least 4 log reduction of viruses and bacteria.

It is a further object of the present invention to provide a fabric for purification of liquids which provides high flow rates in a water purification system.

The present inventors have surprisingly found that a fabric having a matrix of polymer impregnated with organosilane superimposed on a surface of the fibre of a fibrous support not only provides reduction of viruses from a liquid to be purified at low pressure drops but also removes bacteria without using a separate microfiltration membrane and also retains high flow rates.

### SUMMARY OF THE INVENTION

According to a first aspect is disclosed a fabric for purification of liquids comprising a fibrous support composed of fibres and a matrix of polymer with organosilane impregnated, wherein the matrix of polymer is superimposed on the surface of the fibres.

According to a second aspect is disclosed a method of preparing a fabric according to the first aspect comprising the steps of:
i. preparing a solution of a polymer and pore forming agent in a solvent and adding organosilane into the solution to obtain a suspension;
ii. contacting the suspension of step (i) with the fibrous support composed of fibres;
iii. rinsing the fibrous support of step (ii) in an antisolvent, the solvent simultaneously precipitating the polymer to form a matrix of polymer with organosilane impregnated therein which matrix is superimposed on the fibres.

According to a third aspect of the disclosed invention is provided use of the fabric of first aspect for preparing a filter for water purification.

According to a fourth aspect of the present invention is disclosed a filter for purification of water comprising fabric according to the first aspect, wherein the fabric is compacted in a manner that the liquid passes through superimposed layers of at least two fabric sheets.

According to a further aspect of the present invention is disclosed the use of a filter of the fourth aspect for providing at least 2 log reduction of bacteria or viruses in a liquid.

According to a further aspect of the present invention is disclosed a method of preparing a filter for purification of liquids, the method comprising: providing the fabric according to the first aspect or preparing the fabric according to method of second aspect and compacting the fabric in a manner that the liquid passes through superimposed layers of at least two fabric sheets.

Throughout the description, the term “log reduction” as used herein means a 10-fold or 90% reduction in the number of viable microorganisms. By “2 log” reduction it is meant that the number of viable bacteria is reduced by 9.9%. By “4 log” reduction it is meant that the number of viable bacteria is reduced by 99.99%.

### DETAILED DESCRIPTION OF THE INVENTION

According to a first aspect disclosed is a fabric for purification of liquids comprising a fibrous support composed of fibres and a matrix of polymer with organosilane impregnated, wherein the matrix of polymer is superimposed on the surface of the fibres.

The fabric of the present invention may be in the form of a flat film or a sheet or has a hollow fibre configuration.

Preferably the fabric has a flux from 1000 litres per square meter per hour to 10000 litres per square meter per hour at 2 psig pressure, more preferably the fabric has a flux from 1500 litres per square meter per hour to 8000 litres per square meter per hour at 2 psig pressure.

For the purposes of this invention the word ‘impregnate’ is meant to be understood as a substance being incorporated into the hollow fibre membrane during the process of formation of the fibre.

Fibrous Support

Disclosed fabric includes a fibrous support. The fibrous support is preferably a reinforcing fabric which is selected from woven, knitted or non-woven fabric, it is preferred that the fibrous support is a non-woven fabric. Preferably the fabric may be made of natural fibers or are of synthetic origin. It is preferred that the fibrous support is of synthetic origin more preferably polymeric. Suitable fibrous support may be made from polymeric fabric which includes but not limited to cotton, polyester, polypropylene, polycotton, nylon or mixtures thereof.

Preferably, the pore size distribution of the fibrous support is in the range of 1 to 400 micrometers, more preferably in the range of 10 to 300 micrometers, most preferably in the range of 25 to 200 micrometers and still more preferably from 35 to 150 micrometres.

The fibrous support preferably has a thickness in the range of 0.5 to 10 millimetres, more preferably in the range of 1 to 6 millimetres. The total surface area of the fibrous support is preferably from 100 to 2500 cm² more preferably from 200 to 1500 cm².

The fibrous support preferably has an area density of 50 to 1000 grams per square meter (GSM) more preferably the GSM is from 75 to 800 still more preferably the GSM is from 100 to 500 and further preferably the GSM ranges from 150 to 400 and most preferably 200 to 300 GSM.

Matrix of Polymer

Disclosed fabric includes a matrix of polymer with organosilane impregnated therein. The matrix of polymer is superimposed on the surface of the fibres of the fibrous support.

The polymer is preferably a thermoplastic polymer. Thermoplastic polymers are polymers that soften when exposed to heat and return to their original condition when cooled to room temperature.

Disclosed matrix of polymer is preferably prepared from any one of the polymer selected from, polyacrylonitriles, polyamides, polyolefins, polyesters, polysulfones, polyethersulfones, polyether ketones, sulfonated polyether ketones, polyamide sulfones, polyvinylidene fluorides, and other chlorinated polyethylenes, polystyrenes and polytetrafluorethylenes or mixtures thereof. More preferred polymers are polyolefins, polyester, polyacrylates, polysulfones, polyvinylidenefluoride, aromatic polysulfones, aromatic polyphenylene-sulfones, aromatic polyethersulfones, polyamide, and their copolymers. It is still preferred that the polymer is selected from polyamides, polyacrylonitriles, polysulfones, polyethersulfones, polyvinylidenefluoride or a mixture thereof. Polysulfones, polyethersulfone, polyvinylidenefluoride are the most preferred.

Preferably the ratio of the total weight of polymer to the total weight of fibrous support is 1:1 to 1:5 more preferably the ratio is 1:1.1 to 1:4, still more preferably the ratio is 1:1.2 to 1:2.

Organosilanes

Monomeric silicon chemicals are known as silanes. A silane that contains at least one carbon-silicon bond (Si—C) structure is known as an organosilane. The common use of organosilane is as microbiocide and hydrophobic agent. The organosilane is soluble in ethanol. The organosilane of the present invention is selected from the group of Octadecyl Dimethyl (3-Triethoxy silyl propyl) Ammonium Chloride, Octadecyl Dimethyl (3-Trimethoxy silyl propyl) Ammonium Chloride and Octadecyl Dimethyl (3-Trihydroxy silyl propyl) Ammonium Chloride.

Method of Preparing the Disclosed Fabric

According to a second aspect is disclosed a method of preparing a fabric according to the first aspect comprising the steps of:
i. preparing a solution of a polymer and pore forming agent in a solvent and adding organosilane into the solution to obtain a suspension;
ii. contacting the suspension of step (i) with the fibrous support composed of fibres;
iii. rinsing the fibrous support of step (ii) in an antisolvent, the solvent simultaneously precipitating the polymer to form a matrix of polymer with organosilane impregnated therein which matrix is superimposed on the fibres.

To begin with, the method of preparing the fabric includes the step of preparing a solution of a polymer and pore forming agent in a solvent. The solvent is preferably selected from N-methylpyrrolidone, dimethylformamide, dimethyl sulphoxide, dimethylacetamide or mixtures thereof.

The pore forming agent is preferably selected from polyvinylpyrrolidone (PVP), polyethylene glycol (PEG), polyvinyl alcohol (PVA) or mixtures thereof. It is highly preferred that the pore forming agent is polyvinylpyrrolidone (PVP). It is highly desired that the pore forming agent is added to the solution such that the ratio of the amount of the pore forming agent to the amount of the polymer is 1:1 to 1:5 more preferably 1:1.5 to 1:3 more preferably 1:1.7 to 1:2.The pore forming agent is soluble in the solvent and also the antisolvent. The pore forming agent dissolves in the antisolvent which results in the pores formed within the matrix of polymer.

Organosilane is added to the solution of a polymer and pore forming agent in a solvent to obtain a suspension. The organosilane may be added as in particle form or added after dissolution in an antisolvent. When the organosilane is added in particle form, it is followed by stirring of the suspension of step (i). When Organosilane is dissolved in an antisolvent, the antisolvent is preferably selected from alcohol, polyol, ketone, water or a mixture thereof and is preferably used for dissolving organosilane into the dope and making dope composition preferably close to cloud point. It is preferable antisolvent to use alcohol as an antisolvent for dissolving organosilane, and most preferably Ethanol.

The subsequent step involves coating the suspension onto a porous support. The coating can be applied to porous support by any conventional techniques that are familiar to those skilled in the art. The coating layer is formed by spreading 0.5 to 2 litres of the suspension per square meter of the porous support.

The coating temperature may vary from −20° C. to 100° C. and is typically from 0° C. to 25° C. The coating thickness of the matrix of polymer is typically between 50 to 500 micrometers for the fabric, but the broadest range may be between 15 micrometers to 5×10³ micrometers. For hollow fibers or tubular forms, the thickness can be even higher. In order to control the porosity of the matrix of polymer, the wet film on the support may be immersed in a precipitating bath immediately or may be subjected to partial drying for 5 seconds to about 48 hours under ambient conditions or elevated temperatures, under atmospheric conditions or under vacuum.

The next step involves rinsing the fibrous support of step (ii) in an antisolvent, and simultaneously precipitating a matrix of polymer coated onto the porous support where the matrix of polymer includes organosilane impregnated therein.

The antisolvent for immersing the fibrous support of step (ii) is preferably water. The water is usually maintained at a temperature of between 0° C. to 70° C. Preferably after precipitating the matrix of polymer onto the porous support, the next step involves drying the resulting fabric.

The present invention provides use of the fabric of first aspect for preparing a filter for water purification.

A filter for purification of liquids

The present invention provides a filter for purification of water comprising fabric according to the first aspect, wherein the fabric is compacted in a manner that the liquid passes through superimposed layers of at least two fabric sheets.

The filter is prepared by providing the fabric according to the first aspect or preparing the fabric according to method of the second aspect and compacting the fabric in a manner that the liquid passes through superimposed layers of at least two fabric sheets. In a highly preferred embodiment the fabric is wrapped spirally to prepare the filter.

The present invention also provides use of the filter of fourth aspect for providing purification of liquid.

The present invention also provides use of the filter of fourth aspect for providing at least 2 log reduction of bacteria or viruses in a liquid.

The present invention also provides use of the filter of fourth aspect in a liquid purification device.

The present invention provides use of a fabric of the first aspect or a filter of the fourth aspect for providing at least 4 log reduction of viruses and bacteria. According to a further aspect of the present invention disclosed is the use of a fabric of the first aspect or a device of the fourth aspect for providing flux of 1000 litres per square meter per hour to 10000 litres per square meter per hour at 2 psig pressure and still more preferably from 1500 litres per square meter per hour to 8000 litres per square meter per hour at 2 psig pressure.

### EXAMPLES

### Example 1

### Preparation of a Fabric According to the Present Invention

Dope Preparation

Air dried Polysulfone and PVP with required quantity were dissolved in DMAc at 65 0 C. Then required amount of organosilane-ethanol solution (known as first antisolvent) was added in another DMAc at 45 0 C temperature. The first antisolvent was then added slowly to Polysulfone, PVP DMAc solution at temperature of 50-55 0 C until cloudiness appears. When the cloudiness permanently persists, the addition was stopped as the dope reached its cloud point. The dope was allowed to cool down overnight to become clear solution again and ready to be used to extrude the fabric.

Casting of Composite Fabric with Organosilane Biocide

Dope is spread over the non-woven fabric, and excess material wiped off using a doctor's knife. Typically, 20 ml of dope is spread over 200 cm² of fabric. The coated fabric is dipped in the coagulation bath for 10 hours. The Fabric is then immersed in water at room temperature (RT; 25° C.) for one hour, repeated thrice, and dried at RT. Coated fabric was wrapped spirally (3 layers) and to make a filter for microbial testing.

### Example 2

### Evaluation of the Removal of Viruses Using a Cartridge Having a Fabric According to the Present Invention

NSF P231 protocol was followed for bacteria and virus testing. Test water loaded with ˜5 log virus and ˜7 log bacteria was used for testing. MS2 bacteriophage was taken as a representative virus and Escherichia coli was taken as the representative for bacteria.

Filtration of Test Water:

The fabric module prepared according to Example 1 was fixed in the filtration assembly of a top chamber and passed 10 litres of spiked water under gravity head. The output sample was collected after 2 litres of water passed for microbial testing.

TABLE 1

| | | | | Microbial reduction | |
|---|---|---|---|---|---|
| | | Biocide to | | Virus | Bacteria |
| Fabric | Incorporated | Polysulfone | Permeability, | Log | Log |
| configuration | biocide | (w/w) | LMH at 2 psig | Removal | Removal |
| Composite | Nil | 0% | 6000 | <0.5 | <0.5 |
| Fabric | | | | | |
| Polymer | Organo | 20% | 3000 | 5 | 5 |
| Biocide: | quaternary | | | | |
| Composite | silane | | | | |
| Fabric | | | | | |

It can be noted from Table 1 that the fabric without organosilane performed poorly for bacteria and virus rejection, less than 0.5 log removal obtained for both the organisms. But our invention, fabric impregnated with organosilane, resulted in 5 log bacteria and virus removal without compromising the flux significantly.

Determination of the Flux:

The flux of the fabric with and without organosilane according to the present invention was determined in the following manner. Three circular discs of the fabric with a diameter of 6 centimetres were placed one above the other and held firmly in a circular fabric holding assembly. After fitting the circular disc within the fabric holding assembly the exposed region of the circular disc had a diameter of 5 centimetres. The circular fabric holding assembly was fitted at the base a vertically held cylindrical vessel. The cylindrical vessel was open at one end and the base of the vessel had a circular opening for the water to exit the vessel after passing though the filter. The cylindrical vessel was filled with water and a constant water column was maintained in the cylinder throughout the experiment. Initially some amount of water was allowed to flow through the filter until the filter was wet. Thereafter the volume of output water passed through the filter was collected for a duration of 1 minute to obtain the volumetric flow rate in mL per minute. The flux was calculated as flow rate (litres/hr) per cross section area (m2) at certain pressure (psig).

1-12. (canceled)

13. A fabric for purification of liquids comprising a non-woven fibrous support having a pore size in a range from 10 to 300 micrometers composed of fibres and a matrix of polymer with organosilane impregnated therein, and the matrix of polymer is superimposed on a surface of the fibres, wherein total organosilane to total polymer content ranges from 0.1:1 to 1:1 by weight; further wherein the polymer is selected from polyamides, polyacrylonitriles, polysulfones, polyethersulfone, polyvinylidenefluoride or a mixture thereof.

14. A method of preparing a fabric according to claim 13 comprising the steps of:
i. preparing a solution of a polymer and pore forming agent in a solvent and adding organosilane into the solution to obtain a suspension;
ii. contacting the suspension of step (i) with the fibrous support composed of fibres;
iii. rinsing the fibrous support of step (ii) in an antisolvent, the solvent simultaneously precipitating the polymer to form a matrix of polymer with organosilane impregnated therein which matrix is superimposed on the fibres.

15. The method according to claim 14 wherein the pore forming agent is selected from polyvinylpyrrolidone (PVP), polyethylene glycol (PEG), polyvinyl alcohol (PVA) or mixtures thereof.

16. The method according to claim 14 wherein the solvent is selected from N-methylpyrrolidone, dimethylformamide, dimethyl sulphoxide, dimethylacetamide or mixtures thereof.

17. The method according to claim 14 wherein the antisolvent is water.

18. The method according to claim 14 wherein the organosilane is added in particle form or added after dissolution in an antisolvent.

19. The method according to claim 14 wherein in step (i) the organosilane is added in particle form followed by stirring of the suspension of step (i).

20. The fabric for purification of liquids according to claim 1 wherein the fabric is used in a filter for water purification.
